(19) United States
(12) Patent Application Publication
(10) Pub. No.: US 2015/0258962 A1
(43) Pub. Date: Sep. 17, 2015

(54) VEHICLE ACCESS SYSTEM AND METHOD

(71) Applicant: JAGUAR LAND ROVER LIMITED, Whitley, Coventry Warwickshire (GB)

(72) Inventor: Hadric Khanu, Whitley, Coventry (GB)

(21) Appl. No.: 14/438,322

(22) PCT Filed: Oct. 28, 2013
(86) PCT No.: PCT/EP2013/072537

§ 371 Date: Apr. 24, 2015

(30) Foreign Application Priority Data
Oct. 26, 2012 (GB) 1219262.1

(51) Int. Cl. B60R 25/20; G07C 9/00; B60R 25/24

(52) U.S. Cl. CPC B60R 25/2054; B60R 25/24; G07C 9/00309; G07C 2209/64

(57) ABSTRACT

The present invention relates to a vehicle access system (1) having at least one sensor (11) for detecting a user. A controller (9) is provided for controlling the opening and/or closing of a vehicle opening (5). A detector (21) is also provided for detecting a remote unit (19). The controller (9) is configured to activate the at least one sensor (11) when the detector (21) detects the remote unit (19). The invention also relates to a method of controlling access to a vehicle (3).

### TECHNICAL FIELD

The present invention relates to a vehicle access system and method. Aspects of the present invention relate to a system, to a method and to a vehicle.

### BACKGROUND

It is known to provide a powered tailgate on motor vehicles to facilitate access to the vehicle. The powered tailgate can, for example, be activated by pressing a button on a key fob. However, a potential problem arises if the user is carrying objects, such as boxes, luggage, shopping etc., and cannot readily access the key fob.

DE 202010003763 discloses a capacitive sensor arrangement mounted to a tail apron of the vehicle. The capacitor sensor arrangement is configured to detect a swivelling action of the user's foot under the tail apron. Upon detection of the swivelling action, the vehicle tailgate is opened. However, the required gesture to open the tailgate is not intuitive and could cause the user to become unbalanced.

FR 2917771 discloses a method of controlling the automatic closure of a vehicle tailgate. A series of sensors are provided at the rear of the vehicle to establish a detection zone. The closure of the tailgate is initiated by pressing a button within the vehicle and the sensors then perform a check to determine whether the user is present within the detection zone after a prescribed period of time.

The present invention sets out to overcome or ameliorate at least some of the shortcomings associated with the aforementioned prior art techniques.

### SUMMARY OF THE INVENTION

Aspects of the present invention relate to a vehicle access system for controlling access to a vehicle opening. The vehicle access system can be configured to open and/or close the vehicle opening; and/or to lock and/or unlock the vehicle opening. Aspects of the present invention also relate to a method of controlling access to a vehicle.

In a further aspect of the present invention, there is provided a vehicle access system comprising:
at least one sensor for detecting a user;
a controller for controlling access to a vehicle opening; and
a detector for detecting a remote unit;
wherein said controller is configured to activate said at least one sensor when said detector detects the remote unit. The controller can control activation of the at least one sensor to reduce power consumption. Thus, the at least one sensor can be activated only when required to detect the user. The at least one sensor can be deactivated if the remote unit is not detected. Selectively activating and/or deactivating the at least one sensor can reduce the quiescent current of the vehicle access system. The vehicle access system can be configured to open and/or close the vehicle opening; or to lock and/or unlock the vehicle opening.

The detector can detect the remote unit wirelessly. The detector can comprise a base transceiver for communicating with a remote transceiver in said remote unit. The base transceiver can be an ultra-wideband transmitter and/or receiver for establishing a communication channel with said remote unit.

The at least one sensor can comprise a capacitive sensor and/or an ultrasonic sensor. The at least one sensor can be a parking aid sensor or a blind spot sensor. The at least one sensor can be configured to detect the presence/absence of the user; and/or to track the positional movement of the user. The at least one sensor could comprise a plurality of transceivers for tracking the positional movement of the remote unit and thereby indirectly tracking the user.

The remote unit could be a dedicated unit to be carried by a user. For example, the remote unit can be a key fob for controlling operation of the vehicle. The remote unit could transmit an identification signal for detection by detector. The identification signal could be transmitted continuously or intermittently. Alternatively, the remote unit could be configured to transmit the identification signal in response to a signal transmitted by the detector.

The at least one sensor could detect the presence or absence of a user. Alternatively, the at least one sensor can be operable to track positional movement of the user. The at least one sensor can track the distance to the user to generate the positional movement pattern. The controller can include a positional comparator for comparing a detected positional movement pattern with one or more pre-defined movement maps. The controller can be configured to open the vehicle opening when said positional comparator determines that the positional movement pattern at least substantially corresponds to a first of said one or more pre-defined movement maps. Alternatively, or in addition, the controller can be configured to close the vehicle opening when the positional comparator determines that the positional movement pattern at least substantially corresponds to a second of said one or more pre-defined movement maps.

The at least one sensor can be configured to monitor the position of the user within an operating zone. In particular, the at least one sensor can measure the range (i.e. distance) to the user within the operating zone. The at least one sensor can be configured to monitor the position of the user as they move relative to the vehicle within said operating zone. The positional movement pattern can be generated by said at least one sensor based on the movements of the user within the operating zone. The operating zone can correspond to a maximum detection range of said at least one sensor.

The at least one sensor can be configured to measure the distance to the user continuously. Alternatively, the at least one sensor can be configured to measure the distance to the user intermittently, for example at predetermined time intervals.

The present invention also relates to a vehicle having a vehicle access system of the type described herein.

In a still further aspect of the present invention, there is provided a method of controlling access to a vehicle, the method comprising:
detecting a remote unit;
activating at least one sensor for detecting a user when said remote unit is detected; and
opening and/or closing a vehicle opening when said at least one activated sensor detects a user.

The remote unit can be detected by establishing wireless communication between a base unit and said remote unit. The base unit can comprise a transmitter and/or receiver for communicating with the remote unit. The remote unit can have a transmitter and/or receiver for communicating with the base unit. The base unit can operate at an ultra-wideband frequency to establish a communication channel with the remote unit.

The at least one sensor can comprise a capacitive sensor and/or an ultrasonic sensor. When activated, the at least one sensor can detect the presence or absence of the user. Alternatively, the at least one activated sensor can track positional movement of the user. The method can further comprise opening and/or closing said vehicle opening when a tracked positional movement pattern at least substantially matches a pre-defined movement map.

The references herein to opening/closing the vehicle opening are to be understood as referring to the opening/closing of the closure member associated with that vehicle opening. The opening/closing of the closure member can comprise unlocking/locking the closure member and optionally also pivoting the closure member to an open/closed position, for example by activating an actuator or drive mechanism. The vehicle access system described herein could be implemented for opening a vehicle door or an access panel (such as a bonnet or a fuel cover). The invention has particular application when implemented to control the opening and/or closing of a tailgate. The term tailgate in the present application refers to hatches provided at the rear of the vehicle to provide access to the interior of the vehicle and includes boot (trunk) lids and the like. The tailgate can be hingedly mounted by one or more hinges provided along an upper or lower edge or along a side thereof. The present invention can also be applied to a split tailgate.

Within the scope of this application it is expressly intended that the various aspects, embodiments, examples and alternatives set out in the preceding paragraphs, in the claims and/or in the following description and drawings, and in particular the individual features thereof, may be taken independently or in any combination. For example, features described with reference to one embodiment are applicable to all embodiments, unless such features are incompatible.

### BRIEF DESCRIPTION OF THE DRAWINGS

One or more embodiments of the present invention will now be described, by way of example only, with reference to the accompanying Figures, in which:

FIG. 1 shows a plan view of a vehicle having a vehicle access system according to an embodiment of the present invention;

FIG. 2 shows a plan view of a vehicle having a modified version of the vehicle access system 1;

FIGS. 3A and 3B show operational flow charts for the vehicle access system;

FIGS. 4A and 4B show charts illustrating the interaction between the user and the vehicle access system according to an embodiment of the present invention;

FIG. 5 shows a plan view of a vehicle having a vehicle access system according to a further embodiment of the present invention;

FIG. 6 shows a schematic representation of the vehicle access system shown in FIG. 5.

### DETAILED DESCRIPTION OF AN EMBODIMENT

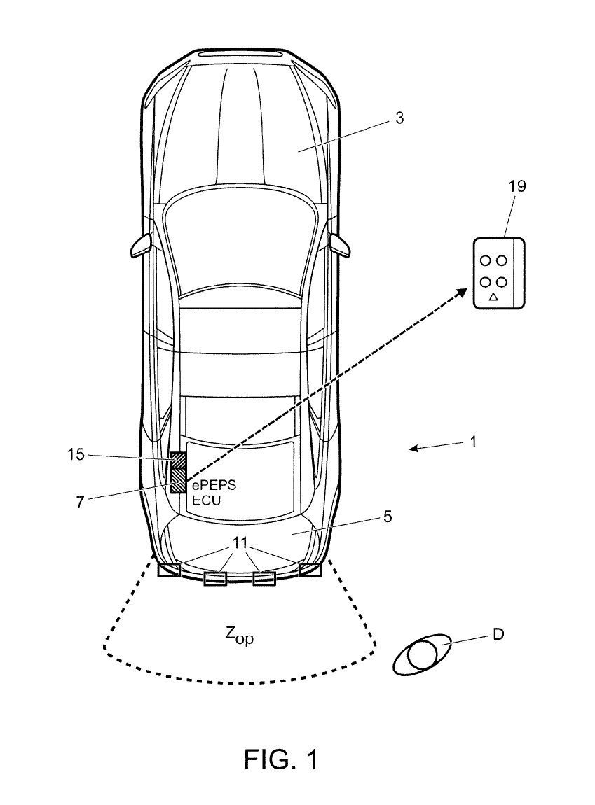

An embodiment of a vehicle access system 1 for a motor vehicle 3 in accordance with the present invention will now be described with reference to FIG. 1. The vehicle access system 1 is configured to control opening and closing of a powered tailgate 5. The tailgate 5 is hinge mounted to the vehicle by first and second hinges (not shown). The vehicle access system 1 comprises a tailgate actuator for opening and closing the tailgate; and a tailgate locking mechanism for locking and unlocking the tailgate.

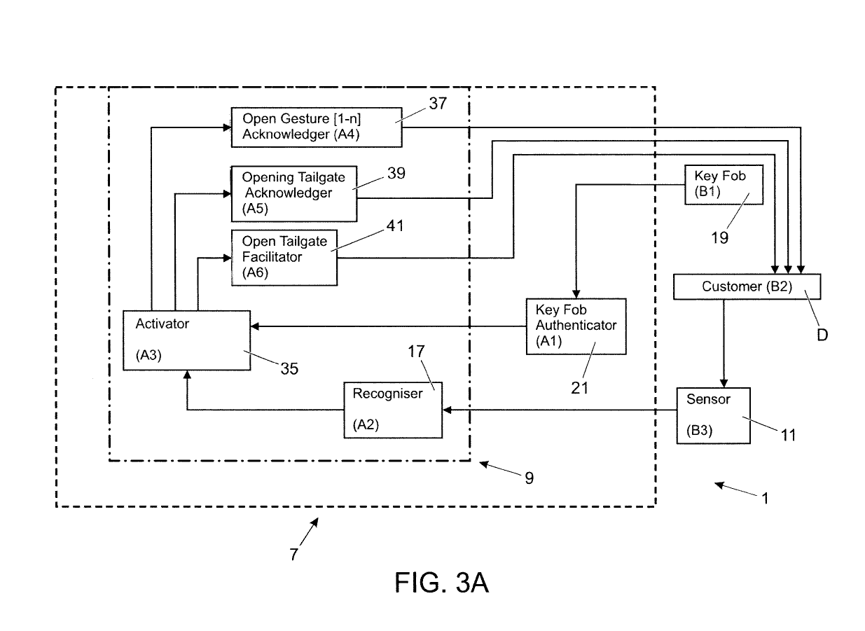

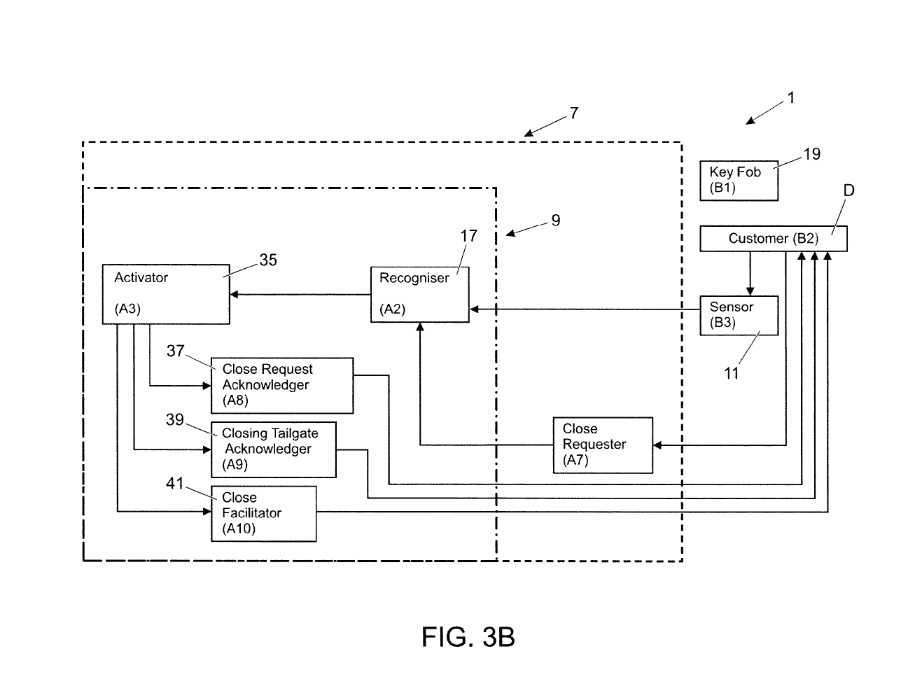

The vehicle access system 1 comprises an electronic control unit 7 having a controller 9 configured to generate control signals to control operation of the tailgate actuator to open/close the tailgate 5; and the locking mechanism to lock/unlock the tailgate 5. As shown in FIGS. 3A and 3B, the controller 9 comprises the following control modules: an activator 35, a request acknowledger 37, a tailgate acknowledger 39 and a tailgate facilitator 41. The activator 35 controls the request acknowledger 37, the tailgate acknowledger 39 and the tailgate facilitator 41 in opening and closing modes depending on the operating mode of the vehicle access system 1. The request acknowledger 37 is configured to provide feedback to the user D to indicate that the tailgate 5 has been primed for opening or closing. The tailgate acknowledger 39 is configured to provide feedback to the user D that the tailgate 5 is being opened or closed. The tailgate facilitator 41 is configured to control the tailgate actuator and the locking mechanism.

The controller 9 is in communication with an array of sensors 11 for tracking a positional movement pattern of a user D in relation to the vehicle 3. The controller 9 uses the data generated by the sensors 11 to track directly the position of the user D relative to the vehicle 3. For example, the controller 9 can compare the positional data (comprising a distance measurement and optionally also a directional measurement) obtained from each sensor 11 to track the position of the user D. The controller 9 can thereby generate a positional movement pattern of the user D at least substantially in real-time. The controller 9 could optionally perform vector analysis in respect of each component part of the positional movement pattern.

In the present embodiment, the sensors 11 are provided in a rear body panel 13, such as a rear protective panel or apron. The sensors 11 in the present embodiment are ultrasonic sensors 11 which are also used as a parking aid, for example forming part of an existing Parking Distance Control (PDC) system. The sensors 11 could be provided in one or more locations, for example along a rear apron, or behind a vehicle registration plate. Moreover, other sensors can be used in place of, or in combination with, the ultrasonic sensors 11. For example, capacitive sensors could be utilised. In the present embodiment, there are four sensors 11a-d but it will be appreciated that less than four or more than four sensors 11 could be utilised.

The controller 9 further comprises a storage device 15, such as a non-volatile memory, containing a plurality of movement maps which each relate to a corresponding control event controlled by the controller 9. By way of example, a first movement map corresponds to a first control event for opening the tailgate 5; and a second movement map corresponds to a second control event for closing the tailgate 5. Several of said movement maps could be associated with the same control event to provide different activation sequences. The movement maps each comprise one or more criteria. For example, the criteria can relate to one or more of the following: (a) location of the user D relative to the vehicle 3; (b) positional movement of the user D relative to the vehicle 3; (c) direction of movement of the user D relative to the vehicle 3; and (d) speed of movement of the user D relative to the vehicle 3. The criteria each correspond to the component positional movements of a multi-stage procedure. The criteria must be satisfied in sequence to initiate the corresponding control event. The movement maps are stored as coded bitmaps but other techniques could be employed. In the present embodiment, the movement maps are pre-defined, but they could be user-defined or customisable.

The controller 9 further comprises a positional comparator 17 for comparing the tracked positional movement pattern with the stored movement maps. The positional comparator 17 comprises an encoder/decoder block suitable for running a protocol engine to parse and process the positional movement pattern data. The encoder/decoder block can be connected to transponders and detectors (such as the sensors 11) through networking technologies such as Transmission Control Protocol (TCP)/Internet Protocol (IP) or through connectivity to local interconnect network (LIN) or CAN by a dedicated electronic control unit (ECU). Only when the positional movement pattern matches each of the criteria associated with one of the stored movement maps is the associated control event initiated by the controller 9. The criteria making up the first and second movement maps for respectively opening and closing the tailgate 5 will now be described.

The first movement map corresponds to a first control event for opening the tailgate 5 and comprises the following sequential opening criteria:
(i) The sensors 11 detect the user D entering an operating zone Z_{OP} defined at the rear of the vehicle;
(ii) The sensors 11 detect a positional movement of the user D towards the vehicle within the operating zone Z_{OP} (referred to herein as a step-in positional movement), for example a positional movement of between ten (10) and twenty (20) centimetres towards the rear of the vehicle; and
(iii) The sensors 11 detect a positional movement of the user D away from the vehicle within the operating zone Z_{OP} (referred to herein as a step-out positional movement), for example a positional movement of between ten (10) and twenty (20) centimetres away from the rear of the vehicle.

The controller 9 opens the tailgate 5 automatically when these criteria have been satisfied in the above order. One or more processes can be performed in addition to these criteria. For example, the controller 9 can provide feedback to indicate that the tailgate 5 is ready to open. The feedback can be audio and/or visual, for example illuminating a dedicated light emitting diode (LED), or flashing the rear indicator lights. A time delay, for example 0.5 seconds can be introduced following completion of the step-in movement before the feedback is output to the user D. The operating zone Z_{OP} can extend up to three (3) or four (4) metres from the rear of the vehicle, or can extend over a smaller region, for example up to forty (40) centimetres from the rear of the vehicle. The operating zone Z_{OP} can optionally be spaced apart from the rear of the vehicle, for example a boundary of five (5) or ten (10) centimetres can be defined from the rear of the vehicle.

The second movement map corresponds to a second control event for closing the tailgate and comprises the following sequential closing criteria:
(i) The sensors 11 detect that the user D is positioned within the operating zone Z_{OP}, for example within a range of thirty (30) centimetres of the rear (left or right) tail lights; and
(ii) The sensors 11 detect a positional movement of the user D away from the rear of the vehicle 3 within the operating zone Z_{OP} (a step-out positional movement), for example between ten (10) and twenty (20) centimetres from the rear of the vehicle 3.

The controller 9 closes the tailgate 5 automatically when these closing criteria have been satisfied in the above order. Again, the controller 9 can provide feedback to indicate that the tailgate 5 is ready to close.

When the sensors 11 form part of an existing PDC system, they are typically tuned/calibrated and mapped based on detecting objects associated with parking a vehicle. For use in conjunction with the vehicle access system 1 according to the present embodiment, the sensors are mapped to optimise measurement of the position and/or distance to the user for generation of the positional movement pattern. Based on a set of vehicle conditions which are derived from the network, the movement maps will be used so that the parking performance is not compromised and gesture recognition is optimised.

The vehicle access system 1 could be primed by a key fob 19 associated with the vehicle 3. For example, an activation button on the key fob 19 could be pressed to awaken the vehicle access system 1 and activate the sensors 11. However, in the present embodiment, the electronic control unit 7 further comprises a detector 21 for detecting the presence of the key fob 19. The key fob 19 comprises a remote transceiver for communicating with a transceiver provided in the vehicle 3. A wireless ultra-high frequency (UHF) ultra-wide band (UWB) system is used to establish a link between the vehicle 3 and the key fob 19. To minimise the power consumption of the system the vehicle 3 can broadcast a code on a specific frequency/time/code channel to which the key fob 19 can listen. The key fob 19 can be configured only to transmit after decoding this channel. Thereafter the key fob 19 can send a request to establish a link for authentication. A suitable UWB system is described in the applicant's co-pending UK application number GB1119792.8 filed on 16 Nov. 2011, the contents of which are incorporated herein in their entirety by reference.

Upon successful completion of this electronic ‘handshake’ procedure, the position vector variable of the key fob 19 could optionally be used by the positional movement pattern recognition procedure to open the aperture(s). In the present embodiment, the vehicle access system 1 is activated and the sensors 11 primed to track the positional movement of the user. The vehicle access system 1 is thereby activated automatically without the user having to press an activation button and can provide passive entry to the vehicle 3. By activating the sensors 11 only when they are required, power consumption can be reduced. This detection arrangement has particular application for controlling the opening of the tailgate 5. An on-board activation button, for example located in the boot (trunk) of the vehicle, can be used to activate the vehicle access system 1 for closing the tailgate 5.

The operation of the vehicle access system 1 according to the present embodiment of the present invention will now be described. The scenario in which the tailgate 5 is in a closed position will be described first. The key fob 19 is detected by the detector 21 when it comes within range of the vehicle 3 and the vehicle access system 1 is awakened and the sensors 11 activated. When the user D enters the operating zone Z_{OP}, the sensors 11 detect the positional movement pattern of the user D relative to the vehicle 3. The comparator 17 performs a real-time comparison of the positional movement pattern with the movement maps stored in the storage device 15 in order to determine if the user's movements correspond to a stored movement map. When the positional comparator 17 determines that the user's movements match those recorded in a stored movement map, the controller 9 activates the corresponding control event. If the generated movement pattern identifies the user D performing a step-in movement relative to the vehicle, and then performing a step-out positional movement relative to the vehicle, the controller 9 will perform the first control event to open the tailgate 5. Specifically, the controller 9 will send an unlock control signal to the tailgate locking mechanism to unlock the tailgate and an open control signal to the tailgate actuator to open the tailgate 5.

Considering the scenario in which the tailgate 5 is in an open position, the user D primes the vehicle access system 1 by pressing a close button, for example provided inside the vehicle 3 in the vicinity of the tailgate 5 or on the key fob 19. The sensors 11 track the position of the user D and the user's positional movement pattern is compared to the stored movement maps to determine if the user's positional movement corresponds to a stored movement map. When the positional comparator determines that the positional movement of the user matches those in a stored movement map, the controller activates the corresponding control event. For example, if the generated movement pattern identifies the presence of the user D within the operating zone Z_{OP} and then tracks the user D performing a step-out positional movement, the controller 9 will perform the second control event to close the tailgate 5. Specifically, the controller 9 will send a close signal to the tailgate actuator to close the tailgate 5 and optionally also a lock control signal to the tailgate locking mechanism to lock the tailgate 5.

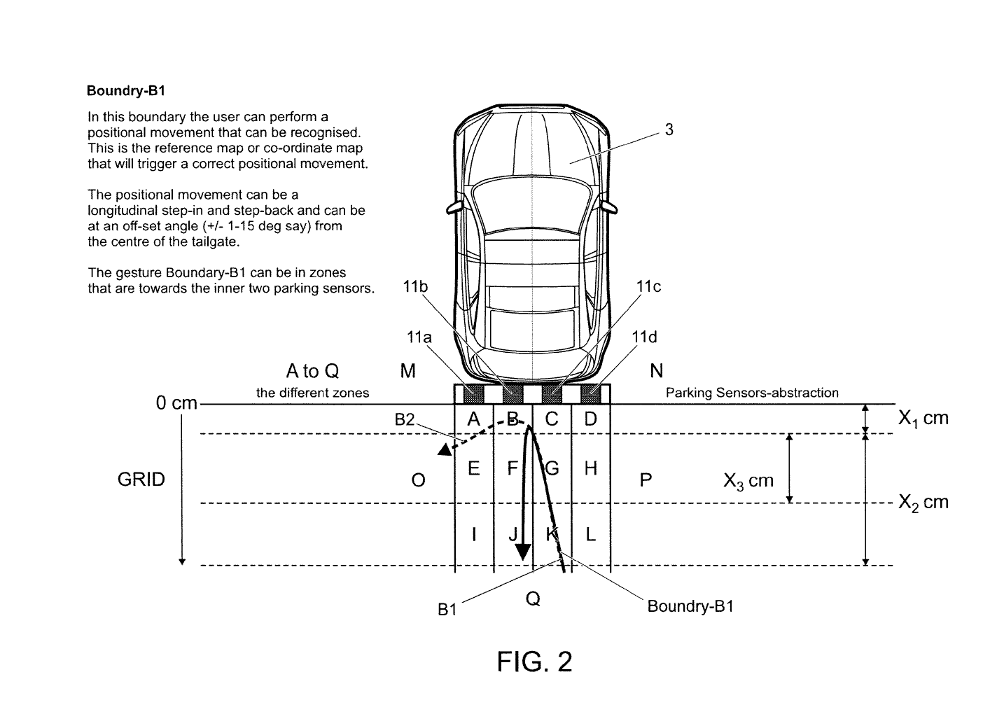

A modified version of the vehicle access system 1 in accordance with the present invention will now be described with reference to FIG. 2. Like reference numerals will be used for like components.

The vehicle access system 1 is modified to define inner, intermediate and outer primary operating zones A-L associated with each of the four sensors 11a-d. In addition, first and second secondary operating zones O, P are defined on the left and right hand sides respectively of the primary operating zones A-L. An aft secondary operating zone Q is defined to the rear of the primary operating zones A-L; and third and fourth secondary operating zones M, N are defined on the left and right hand sides respectively of the vehicle 3. Thus, a total of seventeen operating zones A-Q are defined in relation to the sensors 11a-d. The operating zones A-Q assist with the logic for implementing a control algorithm. This arrangement can provide increased accuracy in the measurement of the positional movement pattern as the user moves in relation to the vehicle 3. The sensors 11a-d can detect the presence or absence of a user in each operating zone A-Q as well as the movement of the user within each operating zone A-Q. The third and fourth secondary operating zones M, N could be monitored by the outermost sensors 11a, 11d, or they could be monitored by separate sensors such as blind-spot sensors. The size and position of each operating zone A-Q can be calibrated.

A first reference movement map B1 is illustrated in FIG. 2 by a continuous line having an arrowhead to indicate the direction of movement. The first movement map B1 represents the positional movement to be traced by a user to open or close the tailgate 5. The first movement map B1 can optionally require that the activation positional movement is performed within a first predefined region relative to the vehicle 3, for example that the activation positional movement is completed in a region between 5 cm and 40 cm from the rear of the vehicle 3. A boundary distance X1, in which the position of the user D is not tracked, is optionally defined at the outer surface of the vehicle 3 to avoid the user D having to touch the vehicle 3. The boundary distance X1 can, for example, have a depth of up to ten (10) centimetres. The first movement map B1 also comprises a step-in positional movement performed over a second minimum predefined distance X2 towards the rear of the vehicle 3, for example a positional movement of at least 5 cm, 10 cm, 20 cm or 30 cm towards the rear of the vehicle 3. The first movement map B1 can optionally also require that the step-in positional movement is performed within a second predefined region relative to the vehicle 3. The first movement map B1 further includes a step-out positional movement over a third minimum predefined distance X3 away from the rear of the vehicle 3, for example a positional movement of at least 5 cm, 10 cm, 20 cm or 30 cm away from the rear of the of the vehicle 3. The first movement map B1 can optionally also require that the step-out positional movement is performed within a third predefined region relative to the vehicle 3. In the present embodiment, the first, second and third distances X1, X2, X3 are measured relative to the rear A-surface of the vehicle 3, but other reference points can be used. The first, second and third distances X1, X2, X3 can be calibrated independently of each other. Similarly, the first, second and third predefined regions can be calibrated.

If the components of the first movement map B1 are completed in sequence, the controller opens or closes the tailgate 5. The step-in and step-out positional movements can be measured relative to a longitudinal axis of the vehicle 3. The controller could be configured to require that the step-in positional movement and/or the step-out positional movement is/are performed substantially parallel to or coincident with said longitudinal axis. Alternatively, the controller can accommodate an angular offset between the longitudinal axis and the step-in positional movement and/or the step-out positional movement. There can be an angular offset between the step-in and step-out positional movements. For example, the step-in and/or step-out positional movements making up the first movement map B1 can each comprise an angular offset in the range of ±1° to 15° or ±1° to 30° from a longitudinal axis of the vehicle 3. The angular offset can be measured relative to a central longitudinal axis of the vehicle 3. The first movement map B1 can optionally be defined to occur near the centre of the tailgate 5. In the present embodiment, the step-in and step-out portions of the first movement map B1 must be detected by the two central sensors 11b, 11c.

It will be appreciated that the first movement map B1 can be modified, for example to require that the user performs a lateral movement after having completed a step-in movement towards the tailgate 5. By way of example, a second movement map B2 is illustrated in FIG. 2 by a dashed line. The second movement map B2 comprises a step-in component X2 to within the predefined range X1. The second movement map B2 then includes a lateral movement to a side of the vehicle 3, for example to a position adjacent to a rear tail lamp cluster.

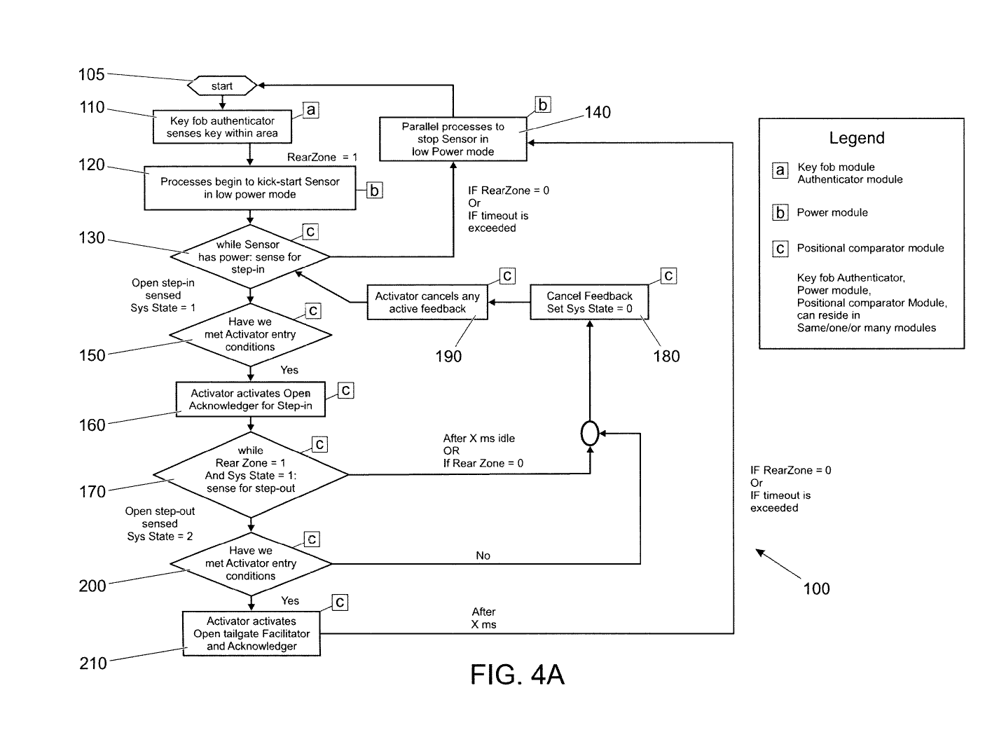

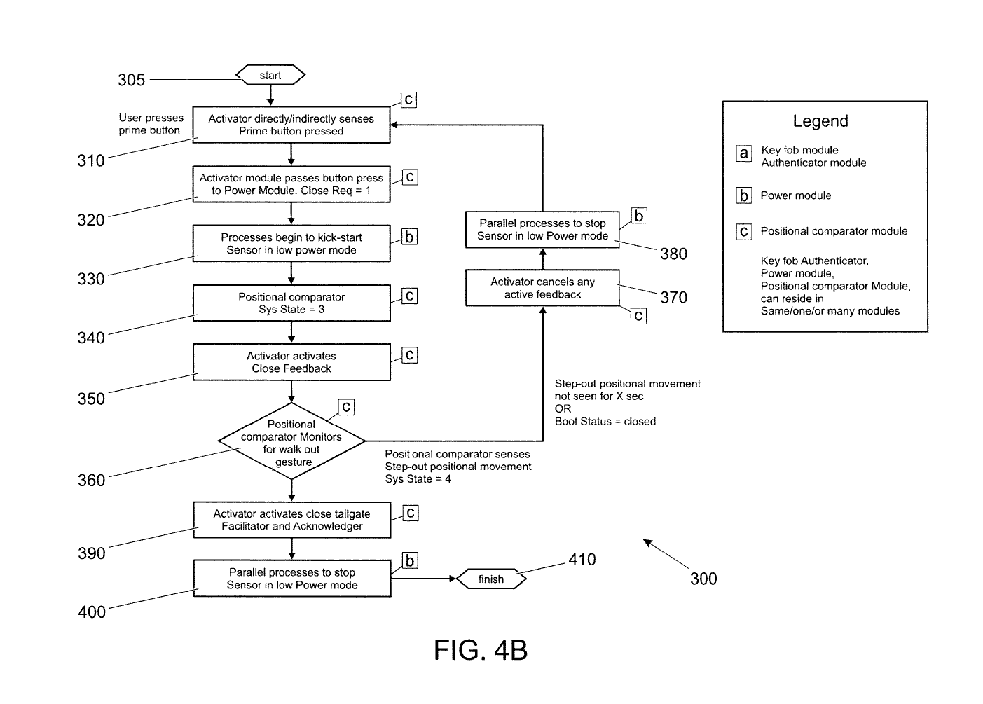

An overview of the interaction between the vehicle 3 and the user D to open the tailgate 5 is illustrated in FIG. 3A. Conversely, an overview of the interaction between the vehicle 3 and the user D to close the tailgate 5 is illustrated in FIG. 3B. The operation of the vehicle access system 1 will now be described with reference to the first and second flow charts 100, 300 shown in FIGS. 4A and 4B.

The opening sequence will be described with reference to the first flow chart 100 shown in FIG. 4A. The vehicle access system 1 is in an active state (STEP 105). The user approaches the vehicle with a key fob 19 and when it is detected within an operating range an electronic ‘handshake’ is performed to authenticate the key fob 19 (STEP 110). If the key fob 19 is authenticated, the controller 9 then activates the sensors 11 provided at the rear of the vehicle (RearZone=1), optionally in a low power mode (STEP 120). The sensors 11 and the positional comparator 17 operate to detect a user D performing a step-in positional movement (STEP 130). If the sensors 11 do not detect a step-in positional movement within a defined time period, the controller 9 switches the sensors 11 off and returns the vehicle access system 1 to its initial active state (STEP 140).

If the sensors 11 detect a step-in positional movement within a defined time period (System State=1), the controller 9 performs a check to determine if the entry conditions of the activator 35 have been satisfied (STEP 150). If the entry conditions have been satisfied, the activator 35 activates the request acknowledger 37 to output feedback to notify the user D that a step-in positional movement has been recognised and that a step-out positional movement should be performed to complete the opening procedure (STEP 160). Provided the key fob 19 has been authenticated (Rear Zone=1) and the step-in positional movement has been recognised (System State=1), the sensors 11 and the positional comparator 17 operate to detect a step-out positional movement (STEP 170).

If the step-out positional movement is not detected in a defined time period, the system is reset (System State=0) (STEP 180) and the activator 35 cancels any active feedback (STEP 190). The key fob 19 has been authenticated (System State=1) and the sensors 11 and the positional comparator 17 operate to detect a step-in positional movement (STEP 130). If the step-out positional movement is detected within a defined time period, a check is performed to determine if the entry conditions defined by the activator 35 have been met (STEP 200). If the entry conditions have been met, the activator 35 activates the tailgate facilitator 41 to open the tailgate 5 (STEP 210); and simultaneously activates the tailgate acknowledger 39 to provide feedback to the user D that the tailgate 5 is opening. After a defined time period, the controller 9 switches the sensors 11 off and returns the vehicle access system 1 to its initial active state (STEP 140).

The closing sequence will be described with reference to the second flow chart 300 shown in FIG. 4B. The vehicle access system 1 is active (STEP 305). The user D awakens the vehicle access system 1 by pressing a prime button provided inside the vehicle 3 (STEP 310). The activator 35 passes a control signal from the prime button to a power module (STEP 320) to activate the sensors 11 (Close Required=1), optionally in a low power mode (STEP 330). The activator 35 configures the positional comparator 17 to detect a step-out positional movement (System State=3) (STEP 340) and activates the request acknowledger 37 to output feedback to notify the user D that a step-out positional movement should be performed to complete the closing procedure (STEP 350). The sensors 11 and the positional comparator 17 then seek to detect a step-out positional movement (STEP 360).

If the step-out positional movement is not detected within a defined time period, the activator 35 cancels any active feedback (STEP 370), switches the sensors 11 off (STEP 380) and the vehicle access system 1 is returned to its initial state awaiting activation of the prime button (STEP 310). If the step-out positional movement is detected within the defined time period (System State=4), the activator 35 activates the tailgate facilitator 41 to close the tailgate 5 (STEP 390); and simultaneously activates the tailgate acknowledger 39 to provide feedback to the user D that the tailgate 5 is closing. The activator 35 then switches the sensors 11 off and the closing sequence is completed (STEP 410).

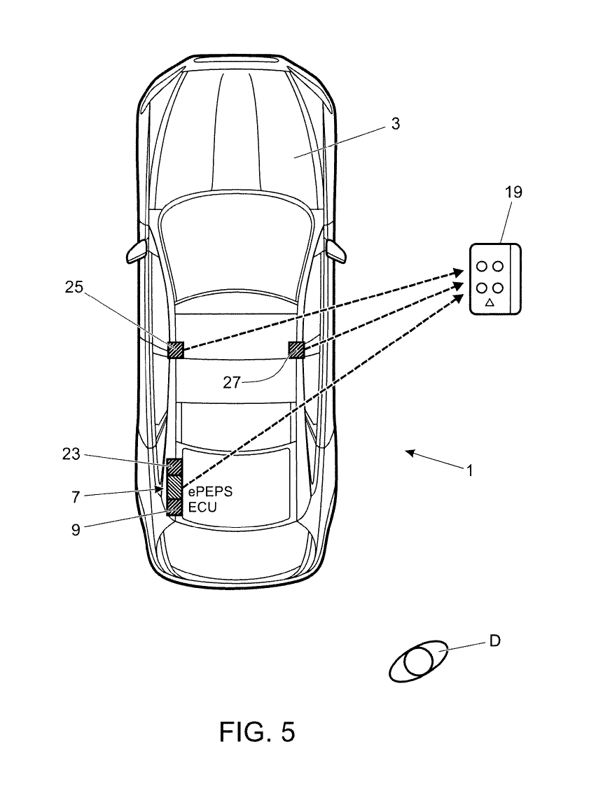

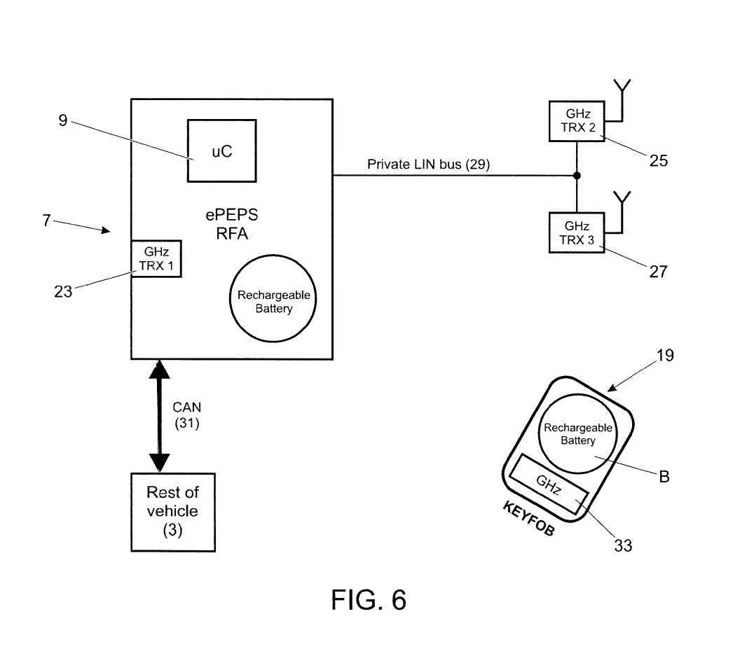

A further embodiment of a vehicle access system 1 in accordance with the present invention will now be described with reference to FIGS. 5 and 6. Like reference numerals will be used for like components. The vehicle access system 1 according to the above embodiment used an array of sensors 11 to track the positional movement of the user D directly. In contrast, the vehicle access system 1 according to the present embodiment utilises an ultra-wide band (UWB) transceiver network to track the positional movement of a key fob 19 carried on the person of the user, thereby tracking the position of the user D indirectly. This arrangement can provide an extension of passive entry and passive starting (PEPS) systems.

As shown in FIG. 5, the vehicle access system 1 comprises an electronic control unit 7 having a controller 9 and three ultra-wideband transceivers 23, 25, 27. The transceivers 23, 25, 27 each have an integrated antenna and are connected to the electronic control unit 7 via a dedicated LIN 29. Alternatively, the transceivers 23, 25, 27 could communicate through networking technologies such as TCP or IP. The controller 9 is also connected to vehicle systems, including the tailgate actuator and a tailgate locking mechanism, via a CAN bus 31. The controller 9 can thereby control opening/closing; locking/unlocking of the tailgate 5. The ultra-wideband transceivers 23, 25, 27 have an operating frequency of between 3.1 GHz and 10.6 GHz and can enable high bandwidth communications with low power consumption. A suitable operating protocol is provided under IEEE 802.15.4a. Furthermore, the sub-set of UWB frequencies designated as Band Group 6 (consisting of Bands #9, #10 and #11, ranging from 7392 MHz to 8976 MHz) can be used.

The key fob 19 for use in accordance with the present embodiment of the vehicle access system 1 is PEPS enabled and comprises a remote ultra-wideband transceiver 33 and a rechargeable battery B. The combination of PEPS and an ultra-wideband transceiver 33 is referred to herein as enhanced-PEPS (ePEPS). The key fob 19 is portable and is typically carried on the person of the user. The key fob 19 communicates with the controller 9 to enable passive entry to the vehicle via the tailgate 5.

The controller 9 and the first transceiver 23 are located at the rear of the vehicle 3 and the second and third transceivers 25, 27 are located in the upper part of the vehicle (typically in the roof) on the right and left sides respectively of the vehicle 3. The transceivers 23, 25, 27 communicate with the remote transceiver 33 provided in the key fob 19. The distance from each of the first, second and third transceivers 23, 25, 27 to the remote transceiver 33 can be determined by measuring transmission and/or response time (for example, time of flight for a signal transmission) thereby allowing the position of the key fob 19 in relation to the vehicle 3 to be determined through triangulation. The use of ultra-wideband frequencies (typically greater than 3 GHz) allows the position of the key fob 19 to be tracked with a relatively high degree of accuracy.

To minimise power consumption, the first transceiver 23 broadcasts a code on a specific frequency/time/code channel to be received by the remote transceiver 33. The remote transceiver 33 can be configured to transmit only after decoding the channel. Thereafter, the remote transceiver 33 can transmit a request to establish an authentication link. The electronic control unit 7 validates the response signal and the position vector of the key fob 19 can be used by the transceivers 23, 25, 27 to track the position of the remote transceiver 33. The second and third transceivers 25, 27 could operate continuously with the first transceiver or they could optionally be activated only once the electronic ‘handshake’ with the remote transceiver 33 has been successfully completed via the first transceiver 23.

If the response signal is not authenticated, the electronic control unit 7 does not track the location of the key fob 19 and no further action is taken. If the response signal is authenticated, the electronic control unit 7 continues to communicate with the key fob 19 and tracks its position (both range and position) in relation to the vehicle 3 by triangulation. The electronic control unit 7 generates a positional movement pattern based on the triangulated position of the key fob 19 in relation to the vehicle 3. The electronic control unit comprises a positional comparator 17 for performing a comparison of the positional movement pattern with a set of stored movement maps. If the positional movement pattern matches one of the stored movement maps, the controller 9 will initiate a control event associated with the identified movement map. The stored movement maps described above can be utilised in this embodiment of the present invention.

While ePEPS is capable of sensing gestures when the person is carrying a key fob 19 under some use cases, the combined use of the sensors 11 (for example forming part of the PDC system) can provide enhanced functionality. For example a locked vehicle where the tailgate has been opened either manually or using gesture detection can be closed and locked without the key present using the close gesture.

At least in certain embodiments, the ePEPS and sensors 11 can share target data over a communications network. For example the improved resolution of the sensors 11 will allow the gesture recognition detection to start before the ePEPS system detects the key is moving, thereby providing improved dynamic performance.

The sensors 11 can also detect the proximity of objects such as another vehicle which is too close to allow the tailgate (or side door) to open safely without causing damage to the vehicle or injury to the user. By sharing data between the systems, a warning can be output to the user before leaving the vehicle that the gesture system is inhibited due to the proximity of objects. The sensors 11 can comprise capacitive sensors and/or ultrasonic sensors and the data generated by the various sensors 11 can be combined to provide improved accuracy.

Opening and closing the tailgate is normally achieved by a step-in and step-out directly behind the rear of the vehicle. In situations where there is restricted access to rear of the vehicle, for example the vehicle is parked too close to another vehicle, an alternative movement map could be selected. The sensors 11 could be configured to detect this scenario and automatically select an alternate movement map (or set of movement maps). The alternative movement map(s) can, for example, be selected to allow the user to approach the rear of the vehicle from either to the left or right hand side at an angle.

It will be appreciated that various changes and modifications can be made to the embodiments described herein without departing from the spirit and scope of the present invention.

For example, the movement sequences required to initiate the control events can be altered. The movement sequences could be modified for different vehicle configurations. For example, if the tailgate is hinged at the side, the movement sequences could be modified to require that the user steps to a particular side of the vehicle. Equally, if the vehicle has a split tailgate, different movement sequences could be associated with each section of the tailgate.

Aspects of an embodiment of the present invention are set out in the following numbered paragraphs.

1. A vehicle access system comprising:
at least one ultrasonic sensor for detecting a user;
a controller for controlling access to a vehicle opening; and
a detector for detecting a remote unit;
wherein said controller is configured to activate said at least one ultrasonic sensor when said detector detects the remote unit.
   2. A vehicle access system as described in paragraph 1, wherein said detector comprises a base transceiver for communicating with a remote transceiver in said remote unit.
   3. A vehicle access system as described in paragraph 2, wherein said base transceiver is an ultra-wide band transceiver.
   4. A vehicle access system as described in paragraph 1, wherein said at least one sensor is a parking aid sensor.
   5. A vehicle access system as described in paragraph 1, wherein the remote unit is a key fob.
   6. A vehicle access system as described in paragraph 1, wherein said at least one ultrasonic sensor is operable to track a positional movement pattern of the user.
   7. A vehicle access system as described in paragraph 6, wherein the controller further comprises a positional comparator for comparing the positional movement pattern with one or more pre-defined movement maps.
   8. A vehicle access system as described in paragraph 7, wherein the controller is configured to open the vehicle opening when said positional comparator determines that the positional movement pattern at least substantially corresponds to a first of said one or more pre-defined movement maps; and/or to close the vehicle opening when the positional comparator determines that the positional movement pattern at least substantially corresponds to a second of said one or more pre-defined movement maps.
   9. A method of controlling access to a vehicle, the method comprising:
detecting a remote unit;
activating at least one ultrasonic sensor for detecting a user when said remote unit is detected; and
providing access to a vehicle opening when said at least one activated ultrasonic sensor detects a user.
   10. A method as described in paragraph 9, wherein said remote unit is detected by establishing wireless communication between a base unit and said remote unit.
   11. A method as described in paragraph 9, wherein an ultra-wideband channel is established to provide communication between said base unit and the remote unit.
   12. A method as described in paragraph 10, wherein said at least one activated ultrasonic sensor tracks a positional movement pattern of the user.
   13. A method as described in paragraph 12, wherein the method comprises opening and/or closing said vehicle opening when said positional movement pattern at least substantially matches a pre-defined movement map.
   14. A vehicle comprising a vehicle access system as described in paragraph 1.

1-22. (canceled)

23. A vehicle access system comprising:
at least one ultrasonic sensor configured for detecting a user;
a controller for controlling access to a vehicle opening;
a detector configured for detecting a remote unit, said detector comprises a base transceiver for communicating with a remote transceiver in said remote unit;
wherein said base transceiver comprises a first ultra-wide band transceiver; and
wherein said controller is configured to activate said at least one ultrasonic sensor when said detector detects the remote unit.

24. A vehicle access system as claimed in claim 23, wherein said sensor comprises at least one parking aid sensor.

25. A vehicle access system as claimed in claim 23, wherein the remote unit is a key fob.

26. A vehicle access system as claimed in claim 23, wherein said ultrasonic sensor is operable to track a positional movement pattern of the user.

27. A vehicle access system as claimed in claim 26, wherein the controller comprises a positional comparator for comparing the positional movement pattern with one or more pre-defined movement maps.

28. A vehicle access system as claimed in claim 23, wherein the remote unit comprises a second ultra-wideband transceiver integrated into a key fob, the second ultra-wideband transceiver being arranged to communicate with said first ultra-wideband transceiver,
wherein the controller is configured to track the positional movement of the key fob as an indication of a positional movement pattern of the user.

29. A vehicle access system as claimed in claim 28, wherein the controller comprises a positional comparator for comparing the positional movement pattern with one or more pre-defined movement maps.

30. A vehicle access system as claimed in claim 28, wherein the controller is configured to open the vehicle opening when said positional comparator determines that the positional movement pattern at least substantially corresponds to a first of said one or more pre-defined movement maps; and/or to close the vehicle opening when the positional comparator determines that the positional movement pattern at least substantially corresponds to a second of said one or more pre-defined movement maps.

31. A method of controlling access to a vehicle, the method comprising:
detecting a remote unit using a base unit for the detecting;
activating at least one ultrasonic sensor for detecting a user when said remote unit is detected; and
providing access to a vehicle opening when said at least one activated ultrasonic sensor detects a user,
wherein an ultra-wideband channel is established to provide communication between said base unit and the remote unit.

32. A method as claimed in claim 31, wherein said at least one activated ultrasonic sensor tracks a positional movement pattern of the user.

33. A method as claimed in claim 32, wherein the method comprises opening and/or closing said vehicle opening when said positional movement pattern at least substantially matches a pre-defined movement map.

34. A vehicle comprising a vehicle access system as claimed in claim 23.
